(19) United States
(12) Patent Application Publication
(10) Pub. No.: US 2024/0004278 A1
(43) Pub. Date: Jan. 4, 2024

(54) LIGHT SOURCE AND LASER PROJECTION DEVICE

(71) Applicant: Hisense Laser Display Co., Ltd., Shandong (CN)

(72) Inventors: Ke Yan, Shandong (CN); Wei Li, Shandong (CN); Youliang Tian, Shandong (CN)

(21) Appl. No.: 18/468,599

(22) Filed: Sep. 15, 2023

Related U.S. Application Data
(63) Continuation of application No. PCT/CN2022/103190, filed on Jun. 30, 2022.

(30) Foreign Application Priority Data
Nov. 9, 2021 (CN) 202111320370.X
Dec. 31, 2021 (CN) 202111662936.7
Dec. 31, 2021 (CN) 202111662949.4

(51) Int. Cl. G03B 21/20

(52) U.S. Cl. CPC G03B 21/2033; G03B 21/2013; G03B 21/2066; G03B 21/208

(57) ABSTRACT

Provided is a light source. The light source includes a laser array including a substrate, and a first row of laser chips and a second row of laser chips disposed on the substrate. The first row of laser chips includes at least one first-color laser chip and at least one second-color laser chip, the first-color laser chip and the second-color laser chip emitting laser beams of different colors, and the second row of laser chips includes at least three third-color laser chips, central wavelengths of two adjacent third-color laser chips in the second row of laser chips being different.

This application is a continuation application of international application No. PCT/CN2022/103190, filed on Jun. 30, 2022, which claims priority to Chinese Patent Application No. 202111320370. X, filed on Nov. 9, 2021, Chinese Patent Application No. 202111662949.4, filed on Dec. 31, 2021, Chinese Patent Application No. 202111662936.7, filed on Dec. 31, 2021, the disclosures of which are herein incorporated by reference in their entireties.

### TECHNICAL FIELD

The present disclosure relates to the field of projection displays, and in particular, relates to a light source and a laser projection device.

### BACKGROUND

Laser projection display technology is a novel technology in the market. Compared with light-emitting diode (LED) projection products, laser projection display technology has the characteristics of clearer imaging, more vivid colors, and higher brightness, which make the laser projection display technology become a mainstream development in the market.

### SUMMARY

Some embodiments of the present disclosure provide a light source. The light source includes a laser array. The laser array includes a substrate, a first row of laser chips disposed on the substrate, and a second row of laser chips disposed on the substrate. The first row of laser chips includes at least one first-color laser chip and at least one second-color laser chip, the first-color laser chip and the second-color laser chip emitting laser beams of different colors. The second row of laser chips includes at least three third-color laser chips. Central wavelengths of two adjacent third-color laser chips in the second row of laser chips are different.

Some embodiments of the present disclosure provide a laser projection device. The laser projection device includes the light source as described above, an optical machine, and a lens head. The light source is configured to emit a laser beam. The optical machine is configured to modulate a beam incident to the optical machine based on an image signal. The lens head is configured to form a projection image by projecting a beam incident to the lens head.

### BRIEF DESCRIPTION OF DRAWINGS

FIG. 1 is a structural diagram of a laser projection device according to some embodiments;

FIG. 2 is a structural diagram of a light source, an optical machine, and a lens head in a laser projection device according to some embodiments;

FIG. 3 is a structural diagram of a light source according to some embodiments;

FIG. 4 is a top view of a laser array in the light source illustrated in FIG. 3;

FIG. 5 is a top view of another laser array in the light source illustrated in FIG. 3;

FIG. 6 is a top view of still another laser array in the light source illustrated in FIG. 3;

FIG. 7 is a top view of yet another laser array in the light source illustrated in FIG. 3;

FIG. 8 is a structural diagram of another light source according to some embodiments;

FIG. 9A is a structural diagram of a light spot of a beam exited from a combining mirror group according to some embodiments;

FIG. 9B is a structural diagram of a light spot formed by a beam exited by a shaping minor group;

FIG. 10A is a structural diagram of still another light source according to some embodiments;

FIG. 10B is a top view of the light source illustrated in FIG. 10A;

FIG. 11 is a schematic diagram of a beam passing through a lens with a cylindrical arc surface;

FIG. 12A is a structural diagram of a light source according to some embodiments;

FIG. 12B is a top view of the light source illustrated in FIG. 12A;

FIG. 13 is a schematic diagram of a beam transmitting through a first cylindrical lens after being exited from a combining minor group;

FIG. 14 is a structural diagram of another light source according to some embodiments;

FIG. 15 is a structural diagram of still another light source according to some embodiments;

FIG. 16A is a structural diagram of yet another light source according to some embodiments;

FIG. 16B is a structural diagram of yet another light source according to some embodiments;

FIG. 17 is a structural diagram of yet another light source according to some embodiments;

FIG. 18 is a structural diagram of a laser array and a first polarization conversion unit in the light source illustrated in FIG. 17;

FIG. 19 is a structural diagram of a light source according to some embodiments;

FIG. 20 is a schematic structural diagram of a laser array, a first polarization conversion unit, and a second polarization conversion unit in the light source illustrated in FIG. 19;

FIG. 21 is a structural diagram of a laser array according to some embodiments;

FIG. 22 is a structural diagram of a laser array, a first polarization conversion unit, and a second polarization conversion unit according to some embodiments; and

FIG. 23 is a structural diagram of another light source according to some embodiments.

### DETAILED DESCRIPTION

The technical solutions in some embodiments of the present disclosure will be clearly and completely described hereinafter in conjunction with the accompanying drawings. The embodiments described are only a portion of the embodiments of the present disclosure and not all of them. Based on the embodiments according to the present disclosure, all the embodiments acquired by those skilled in the art are within the protection scope of the present disclosure.

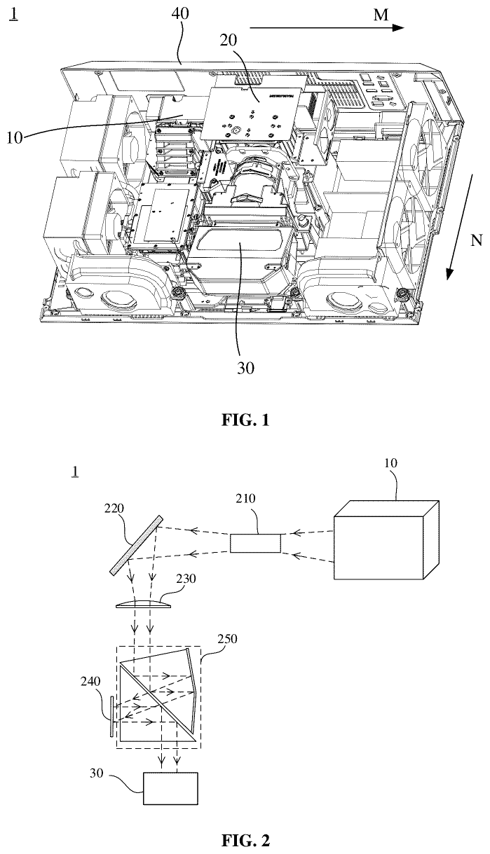

FIG. 1 is a structural diagram of a laser projection device according to some embodiments. Referring to FIG. 1, the laser projection device 1 includes a light source 10, an optical machine 20, and a lens head 30. The laser projection device 1 further includes a housing 40 (only a portion of the housing 40 is illustrated in FIG. 1).

The light source 10 is configured to provide an illumination beam (a laser beam). The optical machine 20 is configured to modulate the illumination beam provided by the light source 10 based on an image signal to acquire a projection beam. The lens head 30 is configured to project the projection beam on a screen or wall to form a projection image. The light source 10, the light machine 20, and the lens head 30 are assembled in the housing 40. The light source 10, the light machine 20, and the lens head 30 are connected in sequence along the beam-transmitting direction.

Each of the light source 10, the light machine 20, and the lens head 30 is wrapped by a corresponding housing. The housings respectively corresponding to the light source 10, light machine 20, and lens head 30 support the corresponding optical components and enable the optical components to meet certain sealing or gas-tight requirements. In some embodiments, the light source 10 is hermetically sealed by its corresponding housing, such that the light decay of the light source 10 is improved.

One end of the optical machine 20 is connected to the lens head 30, and the optical machine 20 and the lens head 30 are arranged along a light-emergent direction of the projection beam of the laser projection device 1 (e.g., parallel to an N direction). The other end of the optical machine 20 is connected to the light source 10.

In some embodiments, an arrangement direction of the light source 10 and the light machine 20 is substantially perpendicular to an arrangement direction of the light machine 20 and the lens head 30 That is, the light-emergent direction of the projection beam (e.g., parallel to the N direction) is substantially perpendicular to a light-emergent direction of the illumination beam (e.g., parallel to an M direction) in the laser projection device 1. This connection structure, in one aspect, accommodates characteristics of an optical path of a reflective light valve (to be described hereinafter) in the optical machine 20 and, in another aspect, is conducive to shortening the length of the optical path in one direction, such that more space is available for arranging the components of the laser projection device 1.

FIG. 2 is a structural diagram of a light source, an optical machine, and a lens head in a laser projection device according to some embodiments. Referring to FIG. 2, the illumination beam emitted by the light source 10 enters the light machine 20. The light machine 20 includes a first homogenizing member 210, a reflector 220, a lens 230, a light valve 240, and a prism assembly 250. The light valve 240 is configured to modulate the illumination beam incident thereto into the projection beam based on the image signal and to direct the projection beam to the lens head 30. The homogenizing member 210 and the light valve 240 are arranged in sequence along the beam-transmitting direction. The first homogenizing member 210 is configured to homogenize the illumination beam incident thereto and direct the homogenized beam to the light valve 240.

In some embodiments, the first homogenizing member 210 is a light conduit. The light conduit receives the illumination beam from the light source 10 and homogenizes the illumination beam. In some embodiments, the light conduit is provided with a rectangular light outlet, such that the light conduit is capable of shaping a light spot of the beam.

The light valve 240 is a reflective light valve. The light valve 240 includes a plurality of reflective sheets, and each of the reflective sheets corresponds to a pixel in the projection image. In some embodiments, based on the projection image to be displayed, reflectors, corresponding to pixels to be displayed in a bright state, of the plurality of reflectors in the light valve 240 reflect the beam to the lens head 30, and the beam that is reflected to the lens head 30 is referred to as the projection beam. In this way, the light valve 240 acquires the projection beam by modulating the illumination beam and implements the display of the image by the projection beam.

In some embodiments, the light valve 240 is a digital micro-mirror device (DMD). The digital micro-mirror device includes a plurality (e.g., thousands of) of microreflectors that are individually driven to rotate. The plurality of microreflectors are arranged in arrays. One of the microreflectors (e.g., each of the microreflectors) corresponds to one pixel in the projection image to be displayed.

The image signal is converted into digital codes such as 0 and 1 upon being processed. In response to the digital codes, the microreflectors oscillate. The grayscale of each pixel in a frame of image is achieved by controlling durations of each of the microreflectors in an on-state or an off-state. In this way, the digital micro mirror device is capable of modulating the illumination beam, and thus the display of the projection image is implemented.

Referring to FIG. 2, in some embodiments, the laser projection device 1 further includes an illumination mirror group between the light valve 240 and the first homogenizing member 210. The illumination mirror group includes a reflector 220, a lens 230, and a prism assembly 250. The beam after being homogenized by the first homogenizing member 210, is directed to the light valve 240 by the illumination mirror group.

The illumination beam from the first homogenizing member 210 is directed to the reflector 220. The reflector 220 reflects the illumination beam incident thereto to the lens 230. In some embodiments, the lens 230 is a convex lens. The lens 230 converges the illumination beam incident thereto to the prism assembly 250. The prism assembly 250 reflects the illumination beam incident thereto to the light valve 240.

Some embodiments of the present disclosure further provide a light source. The light source is a light source for any of the laser projection devices described above. The light source is also a light source in other devices, which is not limited herein.

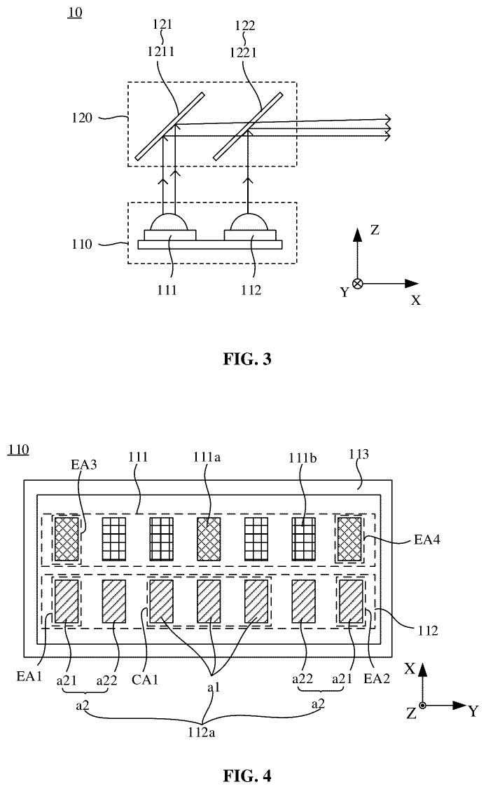

FIG. 3 is a structural diagram of a light source according to some embodiments. FIG. 4 is a top view of a laser array in the light source illustrated in FIG. 3. Referring to FIG. 3 and FIG. 4, the light source 10 includes a laser array 110 and a combining mirror group 120.

The laser array 110 includes a substrate 113, and a plurality of laser chips disposed on the substrate 113. In the laser array 110, a plurality of (e.g., all) laser chips are arranged in an array.

The plurality of laser chips form a first row of laser chips 111 and a second row of laser chips 112. In other words, the laser array 110 includes the first row of laser chips 111 and the second row of laser chips 112. In FIG. 3 and FIG. 4, a direction from the first row of laser chips 111 to the second row of laser chips 112 is referred as a first direction X, and a direction of an arrangement of laser chips in the first row of laser chips 111 is referred as a second direction Y, and a light-emergent direction of each laser chip is referred as a third direction Z.

A row direction of the first row of laser chips 111 and a row direction of the second row of laser chips 112 are parallel to each other and are both parallel to a row direction of the laser chip array (e.g., the second direction Y). An arrangement direction of the first row of laser chips 111 and the second row of laser chips 112 is parallel to a cylindrical direction of the laser chip array (e.g., the first direction X).

The first row of laser chips 111 includes at least one first-color laser chip 111a and at least one second-color laser chip 111b. The second row of laser chips 112 includes at least three third-color laser chips.

In some embodiments, the third-color laser chip is a red laser chip 112a, and the red laser chip 112a is configured to emit red laser beams. The first-color laser chip 111a is configured to emit a first-color laser beam. The second-color laser chip 111b is configured to emit a second-color laser beam. The first-color laser beam and the second-color laser beam are of different colors. In some embodiments, one of the first-color laser chips 111a and the second-color laser chip 111b is a blue laser chip configured to emit a blue laser beam, and the other is a green laser chip configured to emit a green laser beam.

In the light source according to some embodiments of the present disclosure, the number of red laser chips 112a is greater than the number of first-color laser chips 111a and is greater than the number of second-color laser chips 111b. The first row of laser chips 111 does not include the red laser chip 112a, and the second row of laser chips 112 does not include the first-color laser chip 111a and the second-color laser chip 111b. The number of laser chips in the first row of laser chips 111 is equal to the number of laser chips in the second row of laser chips 112. That is, the number of red laser chips 112a is the sum of the number of first-color laser chips 111a and the number of second-color laser chips 111b. In some embodiments, both the first row of laser chips 111 and the second row of laser chips 112 in the laser array 110 include seven laser chips.

During the transmission of light, the degree of divergence of the red laser beam is greater than that of the blue laser beam and the green laser beam, and thus the light loss rate of the red laser beam is greater than that of the blue laser beam and the green laser beam. In this way, the laser projection device requires more red laser to achieve a predetermined white balance while performing the image projection. Based on this, in the light source according to some embodiments, the number of red laser chips is greater than the number of blue laser chips or the number of green laser chips, such that a greater number of red laser beams are provided.

The laser projection device in some practices typically produces the speckle effect while projecting images. In the case that two laser beams emitted by coherent light sources are irradiated on an optically rough surface (i.e., a surface whose average undulation is greater than orders of magnitude of the wavelength), such as a screen used to receive a beam emitted by the laser projection device, the two laser beams interfere in space due to a coherent superposition of sub-waves scattered by a large number of surfaces irregularly distributed on the surface, such that the formed reflected light field has a random spatial light intensity distribution, which presents a granular structure, and eventually granular light and dark spots appear on the screen. These spots are referred to as laser speckles. It should be noted that in a laser array, two laser chips emitting laser light of the same wavelength and constant phase and disposed next to each other are two coherent light sources, which cause the speckle effect. As a result of the speckle effect, the display effect of the projection image is poor, and the unfocused light and dark spots are flickering to the human eye, which is easy to produce a sense of vertigo for a long time, and thus the user's viewing experience is poor.

Referring to FIG. 4, to address the above problem, in some embodiments, center wavelengths of two adjacent third-color laser chips in the second row of laser chips 112 are different. That is, two adjacent red laser chips 112a are different. In some embodiments, a center wavelength of each red laser chips 112a increases in sequence from an edge region (e.g., a first edge region EA1 or a second edge region EA2) to a central region (e.g., a first central region CA1) along a row direction of the second row of laser chips 112a.

In the row direction of the second row of laser chips 112, the second row of laser chips 112 has the first edge region EA1 and the second edge region EA2. The red laser chip 112a is arranged in one of the edge regions. Among the red laser chips 112a, arranged along that row direction, in the second row of laser chips 112, one of two red laser chips 112a on the outmost side is disposed in the first edge region EA1, and the other is disposed in the second edge region EA2.

In the row direction of the second row of laser chips 112, the second row of laser chips 112 further is provided with the first central region CAL In some embodiments, the number V of red laser chips 112a in the second row of laser chips 112 is odd, and the (V+1)/2^{nd} red laser chip 112a is disposed in the first central region CAL Based on this, a plurality of red laser chips 112a are arranged in the first central region CA1, and the plurality of red laser chips 112a are arranged symmetrically with respect to the (V+1)/2^{nd} red laser chip 112a. In some embodiments, the number V of red laser chips 112a in the second row of laser chips 112 is even, and the V/2^{nd} red laser chip 112a and the V/2+1^{st} red laser chip 112a are disposed in the first central region CAL Based on this, a plurality of red laser chips 112a are arranged in the first central region CA1, and the plurality of red laser chips 112a are arranged overall symmetrically with respect to the V/2^{nd} red laser chip 112a and the V/2+1^{st} red laser chip 112a.

It should be noted that the center wavelength of the laser chip refers to the center wavelength of laser light when the laser chip is in normal operation. Based on this, the center wavelength of the red laser chip refers to the center wavelength of red laser light when the red laser chip is in normal operation.

Based on the above, in the row direction of the second row of laser chips 112, the center wavelength of each red laser chip 112a increases in sequences from the first edge region EA1 to the first central region CA1, or from the second edge region EA2 to the second central region CA2. The red light laser emitted by two adjacent red laser chips has different central wavelengths, such the two adjacent red laser chips are not coherent light sources, which are less likely to produce interference. In this way, the speckle effect produced when the laser projection device performs the projection display is improved, such that the display effect of the projection image is improved, and thus the problem of vertigo, when the human eye views the projection image, is improved.

In addition, the red laser chip 112a, which emits red laser light with a short central wavelength, is sensitive to changes in temperature and generates a lot of heat. Based on this, the red laser chip 112a is disposed at an edge of the second row of laser chips. In this way, the heat emitted by the red laser chip 112a is allowed to be effectively distributed to the outside environment, thereby reducing an influence on other red laser chips 112a.

In some embodiments, the second row of laser chips 112 includes at least one first red laser chip a1 disposed in the first central region CA1, and at least two second red laser chips a2 disposed on both sides of the at least one first red laser chip a1. In some embodiments, along the row direction of the second row of laser chips 112, one side of the at least one first red laser chip al is provided with at least one second red laser chip a2, and the other side is also provided with at least one second red laser chip a2.

The at least one first red laser chip a1 has a first central wavelength. Among the at least two second red laser chips a2, central wavelengths of two second red laser chips a2 which are equidistant from the central region CA1 are equal. In this way, in the second row of laser chips 112, a distribution of the central wavelengths of the red laser chips 112a is more regular, thereby improving the display effect of the projection image of the laser projection device.

It should be noted that the distance between the second red laser chip a2 and the central region CA1 is the distance between the center of this second red laser chip a2 and the center of the central region CA1.

In some embodiments, the second row of laser chips 112 includes four second red laser chips a2, such as two second red laser chips a21 and two second red laser chips a22. The two second red laser chips a21 are equidistant from the central region CA1, and the center wavelengths of the two second red laser chips a21 are equal, such as 639 nm. The two second red laser chips a22 are equidistant from the central region CA1 and the central wavelengths of the two second red laser chips a22 are equal, such as 643 nm.

Referring to FIG. 4, in some embodiments, the first-color laser chip 111a is a blue laser chip. The second-color laser chip 111b is a green laser chip. In the row direction of the first row of laser chips 111, at least one first-color laser chip 111a is provided in two edge regions (e.g., a third edge region EA3 and a fourth edge region EA4) of the first row of laser chips 111. That is, in the end of the first row of laser chips 111 along its row direction, a laser chip disposed on the outermost side is a blue laser chip.

In the row direction of the first row of laser chips 111, the first row of laser chips 111 is provided with the third edge region EA3 and the fourth edge region EA4. The edge region of the first row of laser chips 111 is similar to the edge region of the second row of laser chips 112, and the reference is made to the description of the edge region of the second row of laser chips 112 as described above, which is not repeated herein.

The laser beam emitted by the laser chip diverges in the process of propagation, and the optic mirror (e.g., the combining minor group 120) in the light source has a certain angle range for receiving the beam, such that the loss of the laser beams emitted by one or more laser chips disposed at an edge of the first row of laser chips 111 is large. The luminous power of the blue laser chip is higher than that of the green laser chip and the red laser chip. In some embodiments, the luminous power of the red laser chip ranges from 24W to 56W, the luminous power of the blue laser chip ranges from 48W to 115W, and the luminous power of the green laser chip ranges from 12W to 28W. In some embodiments, the luminous power of the red laser chip is 48W, the luminous power of the blue laser chip is 82W, and the luminous power of the green laser chip is 24W. Based on this, the overall luminous power of the laser array 110 is higher by providing the blue laser chip at the edge of the first row of laser chips 111.

In some embodiments, both the edge regions of the first row of laser chip sill in the row direction of the first row of laser chips 111 are provided with the first-color laser chip 111a. At least one first-color laser chip 111a is arranged between the two first-color laser chips 111a respectively disposed in the two edge regions, and the at least one first-color laser chip 111a is arranged between two second-color laser chips 111b. In this way, the plurality of first-color laser chips 111a and the plurality of second-color laser chips 111b are arranged alternatively, such that the uniformity of a combined beam formed by the subsequent combining of the blue laser beam, the green laser beam, and the red laser beam through the combining mirror is improved, thereby improving the display quality of the projection image of the laser projection device.

In some embodiments, the number of second-color laser chips 111b is greater than the number of first-color laser chips 111a in the first row of laser chips 111. The number of blue laser chips with higher luminous power is reduced in the case that the size of the laser array 110 is small. In this way, the number of laser chips in the laser array 110 is reduced without affecting the luminous effect of the laser array 110.

In the second row of laser chips 112, the number of red laser chips 112a is seven. In the first row of laser chips 111, the number of first-color laser chips 111a is three, and the number of second-color laser chips 111b is four. In this way, the number of red laser chips 112a is greater than the number of first-color laser chips 111a and is greater than the number of second-color laser chips 111b, which meets the requirement of laser projection equipment with more red laser. The number of second-color laser chips 111b is greater than the number of first-color laser chips 111a, which reduces the number of laser chips in the laser array 110 without affecting the luminous effect of the laser array 110.

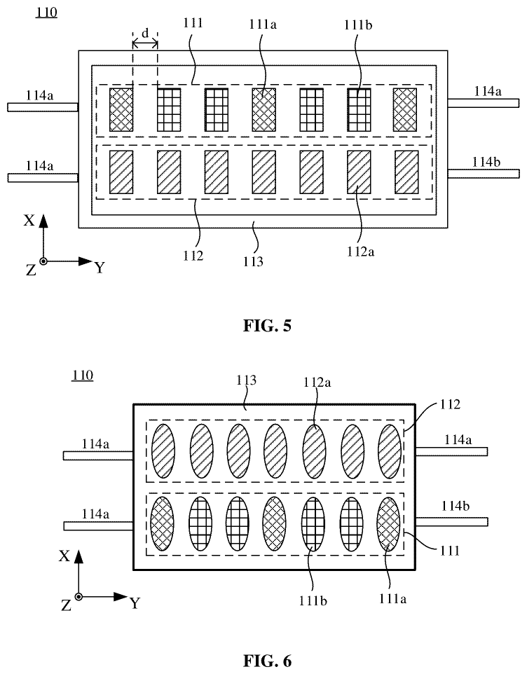

FIG. 5 is a top view of another laser array in the light source illustrated in FIG. 3. Referring to FIG. 5, in some embodiments, the laser array 110 further includes three first conductive pins 114a and one second conductive pin 114b that are arranged on the substrate 113. The three first conductive pins 114a are respectively connected to the first end of a plurality of red laser chips 112a connected in series, the first end of a plurality of first-color laser chips 111a connected in series, and the first end of a plurality of second-color laser chips 111b connected in series. The second conductive pin 114b is connected to the second end of the plurality of red laser chips 112a connected in series, the second end of the plurality of first-color laser chips 111a connected in series, and the second end of the plurality of second-color laser chips 111b connected in series. One of the first conductive pins 114a (e.g., each of the first conductive pins 114a) and the second conductive pin 114b is a positive pin and the other is a negative pin.

It should be noted that a plurality of laser chips connected in series have a first end and a second end. Certain voltages are respectively applied to the first and second ends, which causes the series-connected plurality of laser chips to operate simultaneously. The first and second ends of the series-connected laser chips are respectively connected to the first conductive pin 114a and the second conductive pin 114b. By writing electrical signals to the first conductive pin 114a and the second conductive pin 114b, voltages are applied to the first end and the second end of the series-connected plurality of laser chips, such that the series-connected plurality of laser chips operate. In some embodiments, the first conductive pin 114a and the second conductive pin 114b are further connected to a circuit board (not illustrated in FIG. 5) in the laser projection device, such that the electrical signals are written to the first conductive pin 114a and the second conductive pin 114b through the circuit board.

In some embodiments, the first conductive pin 114a is a positive pin and the second conductive pin 114b is a negative pin. In this case, the plurality of red laser chips 112a connected in series, the plurality of first-color laser chips 111a connected in series, and the plurality of second-color laser chips 111b connected in series share a common negative pin. In some embodiments, the first conductive pin 114a is a negative pin and the second conductive pin 114b is a positive pin. In this case, the plurality of red laser chips 112a connected in series, the plurality of first-color laser chips 111a connected in series, and the plurality of second-color laser chips 111b connected in series share a common positive pin. In this way, in the laser array 110, by sharing either the positive pin or the negative pin, the manufacturing cost of the laser array 110 is reduced and the packaging process of the laser array is simplified.

In some embodiments, the laser array 110 is a multi-chip laser diode (MCL) component, where a plurality of laser chips are packaged on a single substrate to form a surface light source output.

In some embodiments, in the first row of laser chips 111 and the second row of laser chips 112, a distance d between two adjacent laser chips is no more than 3 mm, such as 1.3 mm, 1.5 mm, 2.0 mm, 2,5 mm, or 3.0 mm. In this way, the distance between two adjacent laser chips in the first row of laser chips 111 and the second row of laser chips 112 is small, and thus the overall size of the laser array 110 is further reduced.

In the top view of the laser array 110, one laser chip (e.g., each laser chip) in the laser array 110 is in a rectangular shape, or in other shapes such as an oval shape, which is not limited herein. FIG. 6 is a top view of still another laser array in the light source illustrated in FIG. 3. It should be noted that a position where the laser chip is disposed is identified in FIG. 6 by a light spot of light emitted by the laser chip. The first-color laser chip 111a, the second-color laser chip 111b, and the red laser chip 112a illustrated in FIG. 6 are not to be construed as any limitation on the shape of the corresponding laser chips in some embodiments of the present disclosure.

Referring to FIG. 6, the shape of the light spot emitted by the laser chip in the laser array 110 is elliptical, the fast axis direction of the laser chip is parallel to a major axis of the ellipse, and a slow axis direction of the laser chip is parallel to a minor axis direction of the ellipse. In some embodiments, the fast axis of the laser chip is parallel to the first direction X, and the slow axis of the laser chip is parallel to the second direction Y. Generally, a divergence angle of the fast axis is greater than the divergence angle of the slow axis. In some embodiments, for some laser chips, the divergence angle of the fast axis is more than three times the divergence angle of the slow axis. Thus the light spot formed by the laser chip is roughly elliptical, but is not limited to it.

In some embodiments, the arrangement direction of the first row of laser chips 111 and the second row of laser chips 112 in the laser array 110 is parallel to the fast axis direction of a laser chip (e.g., each laser chip). Accordingly, the row directions of the first row of laser chips 111 and the second row of laser chips 112 are parallel to the slow axis direction of a laser chip. In this way, a difference between a size along the row direction and a size along the cylindrical direction of the laser array 110 is reduced in the premise that the number of laser chips included in the laser array 110 is the same and the light spots of the beams emitted by the laser chips do not overlap.

Referring to FIG. 3, the light source 10 further includes a combining mirror group 120. The combining mirror group 120 is configured to combine laser beams emitted by the laser array 110. The combining mirror 120 is arranged on a light-emergent side of the laser array 110. In some embodiments, an arrangement direction of the combining mirror group 120 and the laser array 110 is substantially perpendicular to the beam-exiting direction of the combining mirror group 120.

In some practices, the light source of the laser projection device includes four rows of laser chips. In the four rows of laser chips, one row of laser chips is a first-color laser chip (e.g., a blue laser chip), one row of laser chips is a second-color laser chip (e.g., a green laser chip), and the other two rows of laser chips are red laser chips. These four rows of laser chips are arranged in sequence along a certain direction. The laser chips emitting laser beams of different colors are disposed in different rows. Therefore, in order to combine the laser beams of different colors, the combining mirror group in the light source needs to combine the laser beams emitted by at least three rows of laser chips. In contrast, referring to FIG. 4, in the light source according to some embodiments of the present disclosure, the first-color laser chip 111a and the second-color laser chip 111b are disposed in the same row, and the combining mirror group combines the laser beams emitted by two rows of laser chips. In this way, the optical path in the light source according to some embodiments of the present disclosure is more concise and the size of the light source is smaller.

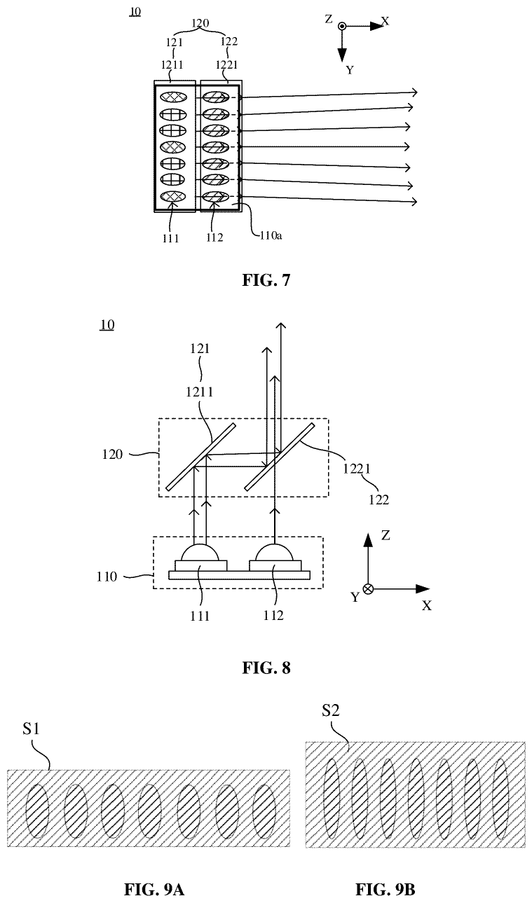

FIG. 7 is a top view of yet another laser array in the light source illustrated in FIG. 3. Referring to FIG. 7, in some embodiments, the combining mirror group 120 includes a first combining unit 121 and a second combining unit 122.

The first combining unit 121 is configured to receive the beam emitted by the first row of laser chips 111. In some embodiments, on a light-emergent surface 110a of the laser array (e.g., a surface parallel to an X-Y plane, wherein the X-Y plane is a plane defined by the first direction X and the second direction Y), at least a portion of an orthographic projection of the first row of laser chips 111 is within an orthographic projection of the first combining unit 121. In this way, at least a portion of the laser beam emitted by the first row of laser chips 111 is irradiated on the first combining unit 121. It should be noted that other elements (e.g., a beam-reducing lens) are or are not provided between the first combining unit 121 and the first laser chip 111 in the light-emergent direction of the first laser chip 111, which is not limited herein, as long as the first combining unit 121 is capable of receiving the laser beam emitted by the first laser chip 111.

The second combining unit 122 is configured to receive the beam emitted by the second row of laser chips 112. In some embodiments, at least a portion of an orthographic projection of the second row of laser chips 112 is within an orthographic projection of the second combining unit 122 on the light-emergent surface 110a of the laser array. In this way, at least a portion of the laser beam emitted by the second row of laser chips 112 is irradiated on the second light combining unit 122. It should be noted that other elements (e.g., a beam-reducing lens) are or are not provided between the second combining unit 122 and the second laser chip 112 in the light-emergent direction of the second laser chip 112, which is not limited herein, as long as the second combining unit 122 is capable of receiving the laser beam emitted by the second laser chip 112.

The arrangement direction of the first combining unit 121 and the second combining unit 122 is parallel to the arrangement direction of the first laser chip 111 and the second laser chip 112. In some embodiments, the arrangement direction of the first combining unit 121 and the second combining unit 122 is parallel to the first direction X.

Based on the above arrangements, the first combining unit 121 is configured to receive the laser beam emitted by each of the first-color laser chips and each of the second-color laser chips in the first row of laser chips 111, and the second combining unit 122 is configured to receive the laser beam emitted by each of the red laser chips in the second row of laser chips 112. The first combining unit 121 and the second combining unit 122 combine the respective received laser beams. In some embodiments, the first combining unit 121 and the second combining unit 122 combine the first-color laser beam emitted by each of the first-color laser chips in the first row of laser chips 111, the second-color laser beam emitted by each of the second-color laser chips, and the red laser beam emitted by each of the red laser chips in the second row of laser chips 112. In some embodiments, an optical path of the laser beam, emitted by the first laser chip 111, exited from the first combining unit 121 substantially coincides with an optical path of the laser beam, emitted by the second combining unit 122, exited from the second laser chip 112.

Compared to some practices where the combining mirror group includes three or even more combining units, the optical path of the combining mirror group in some embodiments of the present disclosure is concise and the optical configuration is simple, such that the optical path of the light source is concise and the size of the light source is further reduced.

Referring to FIG. 7, in some embodiments, the first combining unit 121 includes a first reflector 1211, and the second combining unit 122 includes a semi transmissive-semi reflective minor 1221. The first reflector 1211 is configured to receive the laser beam emitted by the first row of laser chips 111 and reflect the laser beam emitted by the first row of laser chips 111 to the semi transmissive-semi reflective mirror 1221. The semi transmissive-semi reflective mirror 1221 is configured to receive and reflect the laser beam emitted by the second row of laser chips 112 and transmit the laser beam emitted by the first row of laser chips 111. In this way, the first combining unit 121 and the second combining unit 122 combine the laser beam emitted by the first laser chip 111 and the laser beam emitted by the second laser chip 112, and the second combining unit 122 transmits the beam along the arrangement direction (e.g., the first direction X) of the first combining unit 121 and the second combining unit 122.

FIG. 8 is a structural diagram of another light source according to some embodiments. Referring to FIG. 8, in some embodiments, the semi transmissive-semi reflective mirror 1221 is configured to receive and transmit the laser beam emitted by the second row of laser chips 112 and reflect the laser beam emitted by the first row of laser chips 111. In this way, the first combining unit 121 and the second combining unit 122 combine the laser beam emitted by the first row of laser chips 111 and the laser beam emitted by the second row of laser chips 112, and the beam exited from the second combining unit 122 has a propagation direction different from the arrangement direction (e.g., the first direction X) of the first combining unit 121 and the second combining unit 122. In some embodiments, the second combining unit 122 transmits a beam along a direction parallel to the third direction Z.

Referring to FIG. 7 and FIG. 8, because an area of the beam emitted by the first row of laser chips 111 is less than or equal to an overlapping area of the beams emitted by the first row of laser chips 111 and the second row of laser chips 112, an area of the first reflector 1211 is less than or equal to an area of the semi transmissive-semi reflective minor 1221. In this way, the semi transmissive-semi reflective mirror 1221 receives all the beams emitted by the first row of laser chips 111 and the second row of laser chips 112.

The light source 10 successively emits light spots of different colors when operating. In some embodiments, at a moment, the light source 10 emits a light spot of only one color. FIG. 9A is a structural diagram of a light spot of a beam exited from a combining mirror group according to some embodiments. Referring to FIG. 9A, beams emitted by a plurality of homochromatic laser chips are combined to form a rectangular spot S1. The homochromatic laser chips are disposed in the same row in the laser array, and one combining unit (e.g., the first combining unit or the second combining unit) in the combining mirror group is capable of receiving a laser beam emitted by a row of laser chips. Therefore, when the laser array is operating, the size of the light spot S1 acquired after laser beams emitted by one or more homochromatic laser chips disposed in the same row after passing through the combining mirror group is related to positions and arrangements of the one or more homochromatic laser chips.

In some embodiments, the size of a row of laser chips in a row direction is larger than the size in its column direction (the column direction is an arrangement direction of the first row of laser chips and the second row of laser chips, such as perpendicular to the row direction). Therefore, when the one or more homochromatic laser chips emit light, the size of the light spot S1 of the beam exited from the combining minor group is large in one direction of the light spot S1 and is small in the other direction. In some embodiments, the ratio between the long side of the light spot S1 and the short side of the light spot S1 is approximately 3:1 (and sometimes may even reach 7:1). However, an aspect ratio the projection screen used to receive the beam emitted by the light source is roughly 16:9, which results in that the shape of the light spot formed by the beam exited from the combining mirror group does not fit a shape of the projection screen. As can be seen from the calculation formula of etendue in the optical principle, the calculation formula of the etendue of illumination of the laser projection apparatus

In addition, according to the calculation formula of etendue in optical principles, the illumination etendue of the laser projection device is calculated by the following formula.

π×S×(Sin Q)² (1)

In the above formula (1), S is the area of a light-receiving surface of the light valve 240 in the laser projection device, and the light-receiving surface of the light valve herein is usually rectangular, such that the area S of the light-receiving surface of the light valve is expressed as a product of a long side H1 of the light-receiving surface and a short side H2 of the light-receiving surface; Q is an exit angle of the laser beam passing through the lens head 30 in the laser projection device; and after the type of the lens head is determined, a value of F #of the lens head is determined, and F #is a ratio of a focal length of the lens head 30 to an aperture diameter of the lens 30. Therefore, the exit angle Q of the laser beam passing through the lens head is determined based on F #of the lens head, wherein the relationship between F #and Q is as follows: Q=1/(2F #).

That is, the illumination etendue of the laser projection device is calculated by the following formula.

π×H1×H2×Sin²(1/(2F #)) (2)

According to the above formula (2), after the type of the light valve 240 and the type of the lens head 30 are determined, the illumination etendue of the laser projection device is determined, and the Lagrangian invariants of the corresponding long and short sides are determined. However, because the laser beam emitted by the laser array, upon being combined by the combining minor group, forms a light spot whose long side has a larger size than the short side, an exit angle of the laser beam emitted by the combining mirror group in the long side direction of the light spot is greater than that in the short side direction. In this way, the Lagrangian invariant of at least one of the long and short sides of the light spot does not satisfy the requirement.

In some embodiments, the Lagrangian invariant is expressed as the following formula.

n×Sin Q×Y=n′×Sin Q′×Y′ (3)

In the above formula (3), n and n′ are refractive indices of the transmission medium. In the laser projection device, both n and n′ are the refractive indices of air, and thus n=n′. Q is an exit angle of the laser beam passing through the lens head in the laser projection device. Y is an image height of an imaged object. Q′ is an incident angle of the laser beam to the lens head. The laser beam of the light source is reflected or transmitted several times after being exited from the first homogenizing member 210 and incident to the lens. Therefore, Q′ is expressed by an exit angle of the first homogenizing member 210. Y′ is an object height of the imaged object.

A length-width ratio of the imaged picture of the laser beam after passing through the lens head is the same as the length-width ratio of the light-receiving surface of the light valve. Therefore, based on the formula of Lagrangian invariant, the long side of the light spot after being exited from the lens head is expressed as n×Sin (1/(2F #))×H1, and the short side of the light spot after being exited from the lens head is expressed as n×Sin (1/(2F #))×H2. The long side of the light spot when being incident to the lens head is expressed as n′×Sin (Q1′)×d1, and the short side of the light spot when being incident to the lens head is expressed as n′×Sin (Q2′)×d2. d1 is a size of the long side of the light spot formed after the laser beam is combined, and d2 is a size of the short side of the light spot formed after the laser beam is combined. Q1′ is an exit angle of the laser beam incident to the first homogenizing member 210 in the long side direction of the light spot, and Q2′ is an exit angle of the laser beam incident to the first homogenizing member 210 in the short side direction of the light spot.

In order to ensure the high light-emergent efficiency of the laser projection device, the long side of the light spot typically needs to meet the Lagrangian invariant. That is, it is necessary to ensure that k×Sin (1/(2 F #))×H1=Sin(Q1′)×d1, wherein k is a constant.

Q1′ and Q2′ in the above expressions satisfy the following relations:

$$\frac{\frac{1}{2} D 1}{F} = tan Q 1 , \qquad ( 4 )$$

$$\frac{\frac{1}{2} D 2}{F} = tan Q 2 , \qquad ( 5 )$$

In the above formula (4) and formula (5), D1 is a width of a long side of the first homogenizing member 210, D2 is a width of a short side of the first homogenizing member, and F is a focal length of the first homogenizing member. In the laser projection device, the light valve needs to correspond to the first homogenizing member. In other words, a length-width ratio of the first homogenizing member needs to be approximately the same as the length-width ratio of the light-receiving surface of the light valve. In this way, according to the above relationship, a ratio between Q1′ and Q2′ is approximately equal to H1:H2.

The size of the long side of the light spot formed after the laser beam is combined is larger than the size of the short side, thus, when k×Sin(1/(2F #))×H1=Sin(Q1′)×d1, k×Sin (1/(2F #))×H2>Sin(Q2′)×d2. In this way, because the size of the long side of the light spot formed after the laser beam is combined is larger than the size of the short side, the loss of the etendue of the laser beam in the short side direction of the light spot is great, resulting in that the efficiency of the light valve in transmitting the laser beam emitted by the light source is poor.

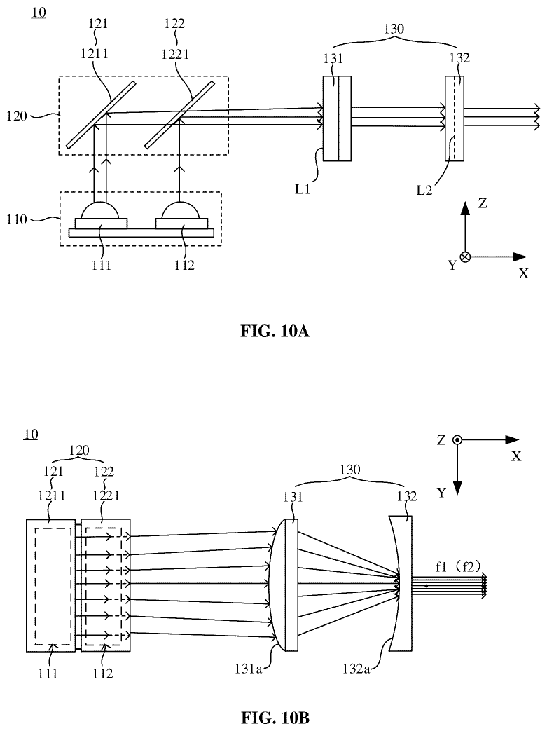

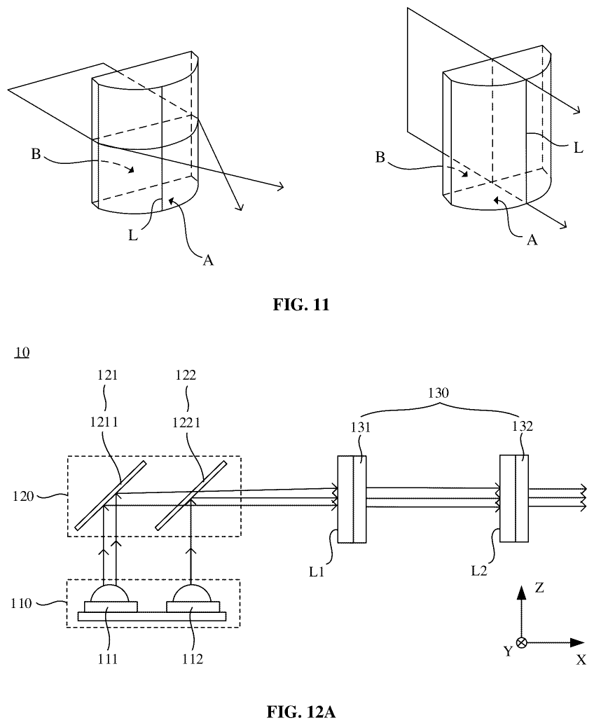

FIG. 10A is a structural diagram of still another light source according to some embodiments. FIG. 10B is a top view of the light source illustrated in FIG. 10A. It should be noted that the specific structures of the first row of laser chips 111 and the second row of laser chips 112 are omitted in FIG. 10B.

Referring to FIG. 10A and FIG. 10B, to address the above problem, in some embodiments, the light source 10 further includes a shaping minor group 130. The shaping minor group 130 is configured to receive the beam exited from the combining minor group 120. In some embodiments, the shaping minor group 130 is arranged in a light-emergent path of the combining minor group 120.

It should be noted that other elements (e.g., a beam-reducing lens 181, which is described hereinafter) are provided between the first cylindrical lens 131 and the combining minor group 120, or no other elements are provided therein between, which is not limited herein, as long as the beam exited from the combining mirror group 120 is capable of transmitting the first cylindrical lens 131 and the second cylindrical lens 132.

The shaping mirror group 130 is configured to shape the received beam such that a width of a light spot of the beam exited from the shaping mirror group 130 in a long side direction of the light spot is smaller than a width of a light spot of the beam incident to the shaping mirror group 130 in the long side direction of the light spot. In this way, the etendue loss of the beam of the short side direction of its light spot is reduced, thereby improving the efficiency of the light valve in transmitting the laser beam emitted by the light source.

In some embodiments, the width of the light spot of the beam exited from the shaping minor group 130 in the long side direction of the light spot is equal to the width of the light spot of the beam incident to the shaping minor group 130 in the short side direction of the light spot. That is, a ratio of the two widths is 1. In some embodiments, when k×Sin(1/(2F #))×H1=Sin(Q1′)×d1, because a value of d1:d2 is 1, k×Sin(1/(2F #))×H2=Sin(Q2′)×d2 is satisfied. In this way, the etendue loss of the laser beam in the short side direction of the light spot is reduced, and thus the efficiency of the light valve in transmitting the laser beam emitted by the light source is further improved.

In some embodiments, the shaping mirror group 130 includes a first cylindrical arc surface 131a and a second cylindrical arc surface 132a. Along the beam-emitting direction of the combining mirror group 120, the first cylindrical arc surface 131a is closer to the combining mirror group 120 than the second cylindrical arc surface 132a is, such that the beam exited from the combining mirror group 120 is incident, through the first cylindrical arc surface 131a, to the second cylindrical arc surface 132a. The shaping mirror group 130 is configured to converge the beam exited from the combining mirror group 120 through the first cylindrical arc surface 131a in a long side direction of a light spot of the beam, and the shaping mirror group 130 is further configured to collimate the converged beam through the second cylindrical arc surface 132a.

FIG. 11 is a schematic diagram of a beam passing through a lens with a cylindrical arc surface. Referring to FIG. 11, a lens having a cylindrical arc surface (which is referred to as a cylindrical surface) has a curvature in a direction perpendicular to a generatrix L of the cylindrical arc surface, which changes the convergence of the beam, and has no curvature in a direction parallel to the generatrix L of the cylindrical arc surface, which does not change the convergence of the beam. In this way, a lens having a cylindrical arc surface is used to change a size in one direction of a beam passing through the lens.

Based on the above, the shaping minor group 130, through the first cylindrical arc surface 131a and the second cylindrical arc surface 132a, reduces a size of a light spot of the beam exited from the combining minor group 120 in a long side direction of the light spot without changing the shape of the light spot in the long side direction.

Referring to FIG. 10A and FIG. 10B, in some embodiments, the shaping mirror group 130 includes the first cylindrical lens 131 and the second cylindrical lens 132. Along a beam-emitting direction of the laser array 110, the first cylindrical lens 131 is closer to the shaping minor group 120 than the second cylindrical lens 132 is. In this way, the beam exited from the shaping mirror group 120 is incident, through the first cylindrical lens, to the second cylindrical lens 132. The first cylindrical lens 131 is provided with the first cylindrical arc surface 131a, and the second cylindrical lens 132 is provided with the second cylindrical arc surface 132a.

FIG. 11 illustrates a cylindrical lens having a cylindrical arc surface. It should be noted that the cylindrical lens in FIG. 11 is a plano-convex cylindrical lens. It should be understood that the cylindrical lens, when being a plano-concave cylindrical lens, has different modulation effects on light in different directions as described hereinafter. The main difference between a plano-convex cylindrical lens and a plano-concave cylindrical lens is that a plano-convex cylindrical lens converges the beam while a plano-concave cylindrical lens diffuses the beam.

Referring to FIG. 11, the cylindrical lens (e.g., the first cylindrical lens or the second cylindrical lens) is provided with a cylindrical arc surface A as described above and a plane B. The cylindrical lens has a curvature in a direction perpendicular to the generatrix L of the cylindrical surface, which changes the convergence of the beam and has no curvature in a direction parallel to the generatrix L of the cylindrical surface, which does not change the convergence of the beam. In this way, the cylindrical lens is used to change a size, in one direction, of a beam passing through the cylindrical lens.

Referring to FIG. 10A and FIG. 10B, in some embodiments, the first cylindrical lens 131 is a plano-convex cylindrical lens having the first cylindrical arc surface 131a. The second cylindrical lens 132 is a plano-concave cylindrical lens having the second cylindrical arc surface 132a. The generatrix L1 of the first cylindrical arc surface 131a is parallel to a generatrix L2 of the second cylindrical arc surface 132a, and a focus point f2 of the second cylindrical lens 132 is in coincidence with a focus f1 of the first cylindrical lens. In this case, a position where the focus f2 of the second cylindrical lens 132 is in coincidence with the focus f1 of the first cylindrical lens 131 is disposed on a side, distal to the first cylindrical lens 131, of the second cylindrical lens 132. In the case that the first cylindrical lens 131 and the second cylindrical lens 132 are arranged in the above manner, substantially parallel beams exited from the combining mirror group 120 are received by the first cylindrical lens 131. The first cylindrical lens 131 converges the beams in a direction perpendicular to the generatrix L1 of the first cylindrical lens 131 (e.g., in a direction parallel to the X-Y plane) and transmits the converged beam to the second cylindrical lens 132. The second cylindrical lens 132 receives the beam, and the second cylindrical lens 132 diverges the beam in a direction perpendicular to the generatrix L2 of the second cylindrical lens 132 (e.g., in a direction parallel to the X-Z plane), such that the beam transmitted to the second cylindrical lens 132 is output approximately parallel. In other words, the second cylindrical lens 132 collimates the beam that has been converged by the first cylindrical lens 131. In this way, the first cylindrical lens 131 and the second cylindrical lens 132 reduce the size of the light spot of the beam in the direction perpendicular to the generatrix L1 of the first cylindrical-shaped arc surface 131a (such as in the direction parallel to the X-Y plane) without changing the shape of the light spot of the beam in that direction. In addition, because the position where the focus f2 of the second cylindrical lens 132 is in coincidence with the focus f1 of the first cylindrical lens 131 is disposed on the side, distal to the first cylindrical lens 131, of the second cylindrical lens 132, the first cylindrical lens 131 is closer to the second cylindrical lens 132, and thus the overall volume of the light source 10 is small.

FIG. 12A is a structural diagram of a light source according to some embodiments. FIG. 12B is a top view of the light source illustrated in FIG. 12A. It should be noted that the specific structures of the first row of laser chips and the second row of laser chips are omitted in FIG. 12B.

Referring to FIG. 12A and FIG. 12B, in some embodiments, the first cylindrical lens 131 is a plano-convex cylindrical lens having the first cylindrical arc 131a. The second cylindrical lens 132 is a plano-convex cylindrical lens having the second cylindrical arc 132a. The generatrix L1 of the first cylindrical arc surface 131a is parallel to the generatrix L2 of the second cylindrical arc surface 132a. The focus f2 of the second cylindrical lens 132 is in coincidence with the focus f1 of the first cylindrical lens. In this case, the position where the focus f2 of the second cylindrical lens 132 is in coincidence with the focus f1 of the first cylindrical lens 131 is disposed between the second cylindrical lens 132 and the first cylindrical lens 131. In the case that the first cylindrical lens 131 and the second cylindrical lens 132 are arranged in the manner described above, substantially parallel beams exited from the combining minor group 120 are received by the first cylindrical lens 131. The first cylindrical lens 131 converges the beams in the direction perpendicular to the generatrix L1 of the first cylindrical lens 131 (e.g., in the direction parallel to the X-Y plane) and transmits the converged beam to the second cylindrical lens 132. The second cylindrical lens 132 receives the beam, such that the beam transmitted to the second cylindrical lens 132 is output substantially in parallel. That is, the second cylindrical lens 132 collimates the beam that has been converged by the first cylindrical lens 131. In this way, the first cylindrical lens 131 and the second cylindrical lens 132 reduce the size of the beam in the direction perpendicular to the generatrix L1 of the first cylindrical lens 131 (e.g., in the direction parallel to the X-Y plane) without changing the shape of the beam in that direction.

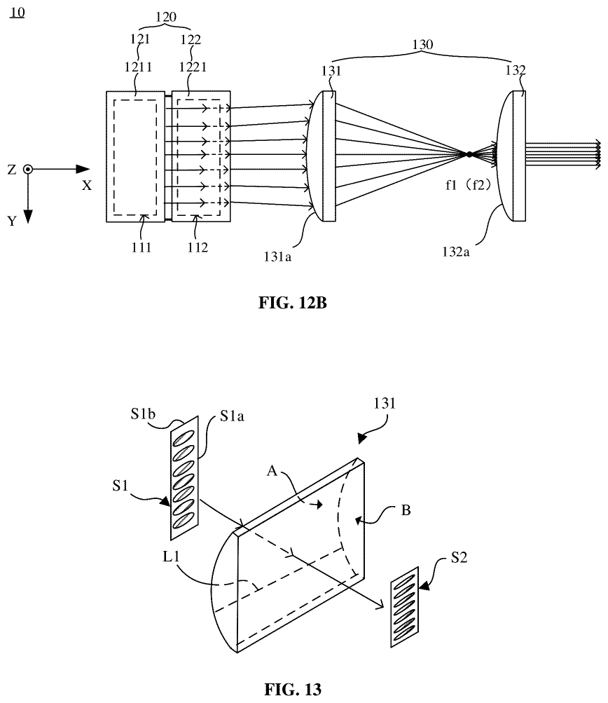

FIG. 13 is a schematic diagram of a beam transmitting through a first cylindrical lens after being exited from a combining mirror group. Referring to FIG. 13, in some embodiments, referring to the description above, the light spot S1 of the beam exited from the combining minor group is a rectangular spot, and a long side S1a of the rectangular spot is perpendicular to the generatrix L1 of the first cylindrical arc surface 131a. Referring to the description above, the first cylindrical lens 131 is a plano-convex cylindrical lens, which reduces the size of the light spot of the beam exited from the combining mirror group in the direction perpendicular to the generatrix L1 of the first cylindrical arc surface 131a. Because the long side S1a of the rectangular spot of the beam exited from the combining mirror group is perpendicular to the generatrix L1 of the first cylindrical arc surface 131a, the first cylindrical lens 131 reduces a size of the light spot S1 in the direction of its long side. In addition, a short side S1b of the rectangular spot of the beam exited from the combining minor group is parallel to the generatrix L1 of the first cylindrical arc surface 131a, such that the first cylindrical lens 131 cannot change a size of the light spot Si in the direction of its short side. In some embodiments, referring to FIG. 9A and FIG. 9B, FIG. 9B shows a structural diagram of the light spot exited by the beam transmitted by the shaping minor group. The first cylindrical lens reduces the size of the light spot Si in the direction of its long side to one-third or one-half of the original size, which forms a light spot S2 illustrated in FIG. 9B. Compared with the light spot S1, a shape of the light spot S2 matches the shape of the projection screen better, which further improves the user experience.

In addition, because the long side of the rectangular spot is perpendicular to the generatrix of the first cylindrical arc surface, the efficiency of the first cylindrical lens in converging the beams exited from the combining mirror group is high. In this way, the beam transmission efficiency in the light source is improved, and the luminance loss due to the greater divergence of the beam exited from the combining mirror group in the transmission process is reduced.

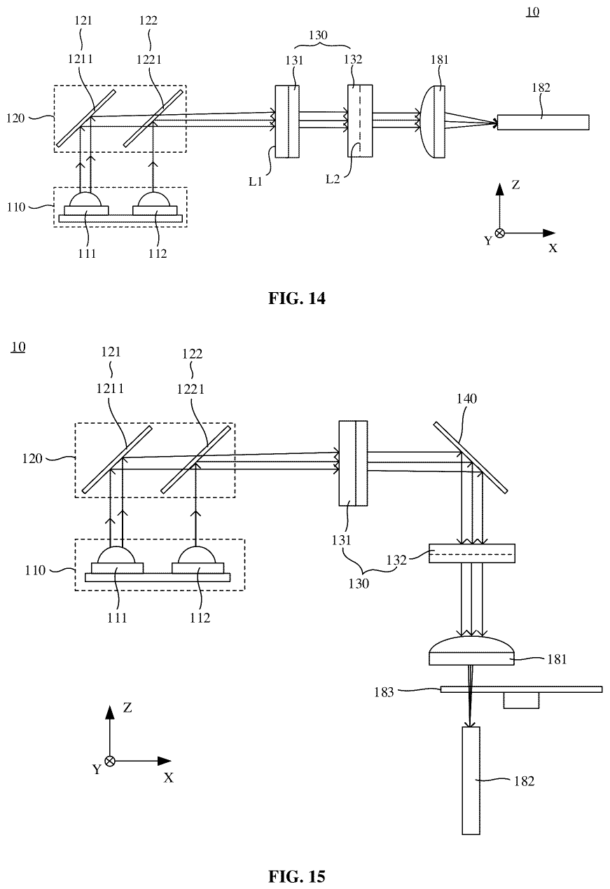

FIG. 14 is a structural diagram of another light source according to some embodiments. Referring to FIG. 14, in some embodiments, the light source 10 further includes a beam-reducing lens 181 and a second homogenizing member 182. In some embodiments, the beam-reducing lens 181 and the second homogenizing member 182 are arranged in sequence along the direction of the optical path. The beam-reducing lens 181 and the second homogenizing member 182 are configured to receive the beam exited from the combining minor group 120 and adjust the beam accordingly.

The beam-reducing lens 181 is a spherical lens or an aspherical lens. In some embodiments, the light source 10 includes two convex lenses (i.e., two beam-reducing lenses 181), which are both spherical lenses. The spherical lens is easier to shape and control the accuracy than the aspheric lens, and thus the difficulty and cost in manufacturing the light source is less. The above two convex lenses are aspheric lenses, which are not limited herein.

The second homogenizing member 182 is configured to perform shaping and homogenizing on the received beam. It should be noted that beam homogenizing refers to shaping a beam with an uneven intensity distribution into a beam with an even intensity distribution.

The second homogenizing member 182 is a light conduit or a compound eye lens. The light conduit is a hollow light conduit, i.e., a tubular device consisting of four planar reflective sheets spliced together. The light conduit is also a solid light conduit. The light is reflected inside the light conduit several times, which achieves the effect of homogenizing light. In some embodiments, an inlet and an outlet of the light conduit are rectangles of the same shape and area. In the case that a beam received by the light conduit has a rectangular light spot, the long side of the rectangular light spot is parallel to the long side of the rectangular inlet of the second light homogenizing member 182. In this way, more beams are allowed to be incident into the second homogenizing member 182, and thus the loss of the beams is reduced.

The beam-reducing lens 181 is configured to converge the beam exited from the second cylindrical lens 132 and direct the converged beam to the second homogenizing member 182. In some embodiments, a focus of the beam-reducing lens 181 is disposed at an in-light surface of the second homogenizing member 182. In this way, the light collection efficiency of the second homogenizing member 182 is improved.

It should be noted that in the case that the light source 10 includes the second homogenizing member 182, the first homogenizing member 210 in the light machine 20 is omitted.

FIG. 15 is a structural diagram of still another light source according to some embodiments. Referring to FIG. 15, in some embodiments, the light source 10 further includes a second reflector 140. The first cylindrical lens 131, the second reflector 140, and the second cylindrical lens 132 are provided along the direction of the optical path in sequence.

The second reflector 140 causes a propagation path of the beam in the light source 10 to be turned, thereby reducing the size of the light source 10 in one direction. In some embodiments, in a direction parallel to the light-emergent direction (e.g., the first direction X) of the light transmitted by the combining mirror group 120, the size of the light source 10 is small. In some embodiments, the arrangement direction of the first cylindrical lens 131 and the second reflector 140 is perpendicular to the arrangement direction of the second reflector 140 and the second cylindrical lens 132. In this way, the second reflector 140 turns the propagation path of the beam by 90°, which further reduces the size of the light source 10 in one direction (e.g., the first direction X).

As illustrated in FIG. 15, the light source 10 further includes a speckle-eliminating member 183. The speckle-eliminating member 183 is a diffusion wheel or a vibrating diffuser. The speckle-eliminating member 183 has the effect of eliminating speckles, which further improves the homogeneity of the light spot of the laser beam. In some embodiments, along the direction of the optical path, the speckle-eliminating member 183 is disposed between the beam-reducing lens 181 and the second homogenizing member 182. In the case that the speckle-eliminating member 183 is a diffusion wheel, it has the same structure and function as a diffusion wheel 186, and the two members are interchangeable.

In the laser array, light-emitting materials in the laser chips of different colors have different light-emitting mechanisms. In some embodiments, the blue laser chip and the green laser chip use the GaAs light-emitting material to generate the blue laser beam and the green laser beam, while the red laser chip uses the GaN light-emitting material to generate the red laser beam. Due to the different light-emitting mechanisms of the light-emitting materials in the laser chips of different colors, resonant cavities of the red laser chip, the blue laser chip, and the green laser chip oscillate in different directions during the light-emitting process, such that a polarization direction of the red laser beam is different from that of the blue laser beam, and is also different from that of the green laser beam. In some embodiments, the red laser beam is P-polarized light, and the blue laser beam and the green laser beam are S-polarized light. The polarization direction of the P-polarized light is perpendicular to the polarization direction of the S-polarized light.

In the application of the laser projection device, the laser projection device is configured with an ultra-short focus projection screen with high gain and high contrast, such as a Fresnel optical screen, to better reproduce a high brightness and high contrast projection image. The Fresnel optical screen shows significantly different transmittance and reflectance of beams with different polarization directions, therefore, in the case where the polarization direction of the red laser beam is different from that of the blue laser beam and is also different from that of the green laser beam, the luminous fluxes, reflected by the screen into the human eye, of different colors of light are imbalanced, which leads to color cast in partial regions of the projection image, and further causes uneven chromaticity such as “color blocks” in the projection image.

FIG. 16A is a structural diagram of yet another light source according to some embodiments. FIG. 16B is a structural diagram of yet another light source according to some embodiments. Referring to FIG. 16A and FIG. 16B, to address the above problem, in some embodiments, the light source 10 further includes a half-wave plate 184. The half-wave plate 184 is configured to change the polarization direction of the received beam.

Referring to FIG. 16A, in some embodiments, the half-wave plate 184 is arranged between a light-emergent surface of the first row of laser chips 111 and the first combining unit 121. The half-wave plate 184 is set according to wavelengths of the first-color laser beam (e.g., the blue laser beam) and the second-color laser beam (e.g., the green laser beam). In this way, polarization directions of the first-color laser beam and the second-color laser beam emitted by the first row of laser chips 111 are caused to change by 90° after passing through the half-wave plate 184. In some embodiments, the blue laser beam and the green laser beam emitted by the first row of laser chips 111 change to the P polarized light after passing through the half-wave plate 184. In this way, the red laser beam, the first-color laser beam, and the second-color laser beam that are emitted by the light source 10 have the same polarization direction, which improves the problem of uneven chromaticity such as “color spots” or “color blocks” on the projection image.

Referring to FIG. 16B, in some embodiments, the half-wave plate 184 is arranged between a light-emergent surface of the second row of laser chips 112 and the second combining unit 122. The half-wave plate 184 is set according to the wavelength of the red laser beam. In this way, the red laser beam emitted by the second row of laser chips 112 changes a polarization direction by 90° after passing through the half-wave plate 184. In some embodiments, the red laser beam emitted by the second row of laser chips 112 changes to S-polarized light after passing through the half-wave plate 184. In this way, the red laser beam, the first-color laser beam, and the second-color laser beam that are emitted by the light source 10 are polarized in the same direction, which improves the problem of uneven chromaticity such as “color spots” or “color blocks” on the projection image.

In addition, in the case that the beam exiting from the combining minor group 120 has the same polarization direction, the beam has the same optical transmittance or reflectance when passing through the same optical components (e.g., the shaping mirror group 130, the second reflector 140, and the beam reducing lens 181.), such that the homogeneity of the beam is improved and the projection display effect is improved. However, the light emitted by such a light source has strong coherence, resulting in a more serious speckle effect in the projection image of the laser projection device, and thus the display effect of the projection image is poor.

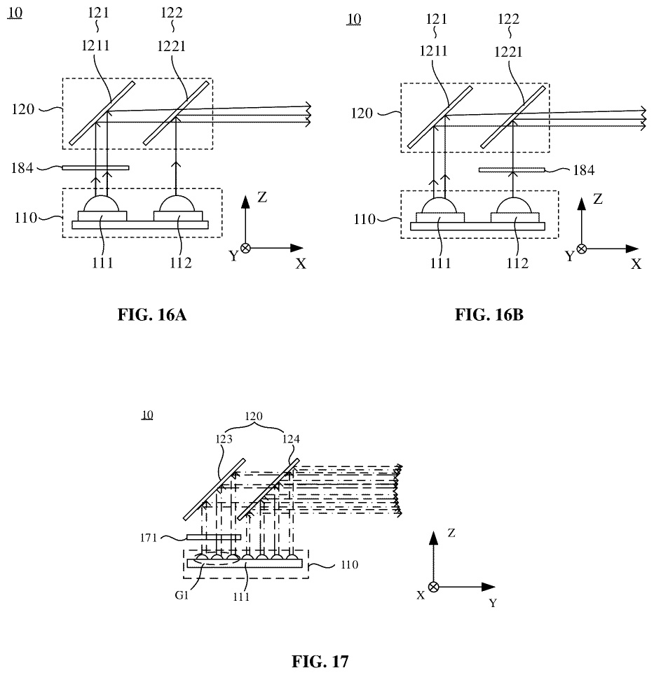

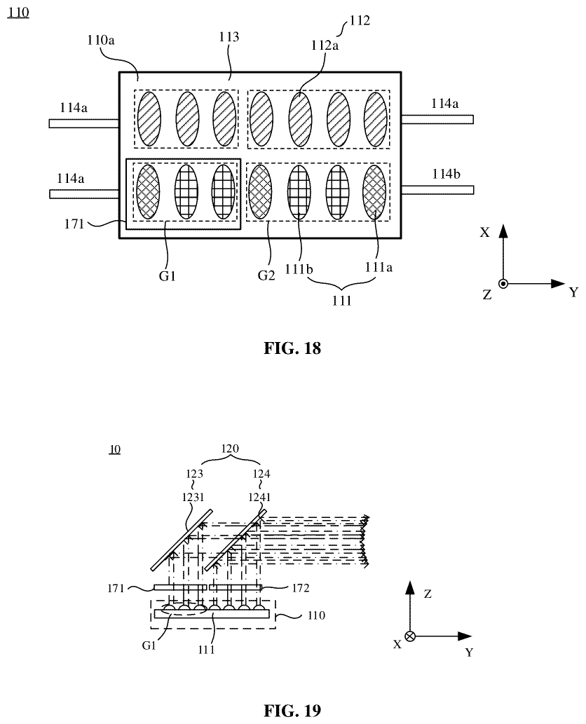

FIG. 17 is a structural diagram of yet another light source according to some embodiments. FIG. 18 is a structural diagram of a laser array and a first polarization conversion unit in the light source illustrated in FIG. 17. Referring to FIG. 17 and FIG. 18, in some embodiments, to address the problem of the speckle effect described above, the light source 10 further includes a first polarization conversion unit 171.

In light source 10, the first row of laser chips 111 includes at least two first-color laser chips 111a. The first row of laser chips 111 includes a first laser chip group G1 and a second laser chip group G2. The first laser chip group G1 includes at least one first-color laser chip 111a and the second laser chip group G2 includes at least one first-color laser chip 111a. That is, both the first laser chip group G1 and the second laser chip group G2 include at least one first-color laser chip 111a.

It should be noted that, as described above, the first-color laser chip 111a is the blue laser chip. In some embodiments, the first-color laser chip 111a is the green laser chip, which is not limited herein.

The first polarization conversion unit 171 is arranged between the first-color laser chip 111a and the combining minor group 120 along the beam-emitting direction of the first laser chip group G1. In some embodiments, the first polarization conversion unit 171 is arranged between the first laser chip group G1 and the combining minor group 120. On a light-emergent surface 110a of the laser array 110, an orthographic projection of the first laser chip group G1 is within an orthographic projection of the first polarization conversion unit 171. In this way, a laser beam emitted by each laser chip in the first laser chip group G1 is incident to the combining mirror group 120 through the first polarization conversion unit 171.

The first polarization conversion unit 171 is configured to change the polarization direction of a laser beam incident to the first polarization conversion unit 171.

Referring to the description above, due to the different light emitting mechanisms of the light emitting materials in the laser chips of different colors, the oscillation direction of the resonant cavity of the red laser chip is different from that of the blue laser chip and the green laser chip during the luminance process, such that the polarization direction of the red laser beam is different from that of the blue laser beam and the green laser beam. In some embodiments, the red laser beam is the P-polarized light, and the blue laser beam and the green laser beam are the S-polarized light. The polarization directions of the P-polarized light and the S-polarized light are perpendicular to each other.

Based on the above, referring to FIG. 17 and FIG. 18, the first polarization conversion unit 171 receives the laser beam emitted by each of the laser chips in the first laser chip group G1 and changes the polarization direction of that laser beam. In some embodiments, the polarization direction of the laser beam is rotated by 90°. In this way, a first-color laser beam emitted by the at least one first-color laser chip 111a in the first laser chip group G1 is incident to the combining mirror group 120 after passing through the first polarization conversion unit 171. Compared with a first-color laser beam emitted by the at least one first-color laser chip 111a in the second laser chip group G2 that is directly incident to the combining minor group 120, the polarization direction of the first-color laser beam emitted by the at least one first-color laser chip in the first laser chip group G1 is deflected by 90° after passing through the first polarization conversion unit 171. In this way, the first-color laser beam incident to the combining mirror group 120 has two polarization directions, which reduces the coherence of the first-color laser beam, and thus the speckle effect of the beam emitted by the laser projection device is improved.

In some embodiments, the first row of laser chips 111 includes at least two second-color laser chips 111b. The first laser chip group G1 further includes at least one second-color laser chip 111b, and the second laser chip group G2 further includes at least one second-color laser chip 111b. That is, both the first laser chip group G1 and the second laser chip group G2 include at least one second-color laser chip 111b.

Because the first polarization conversion unit 171 is arranged between the first laser chip group G1 and the combining mirror group 120, a second-color laser beam emitted by each of the second-color laser chips 111b in the first laser chip group G1 is incident to the combining mirror group 120 through the first polarization conversion unit 171. In this way, similar to the first-color laser beam, the second-color laser beam incident to the combining mirror group 120 also has two polarization directions, which reduces the coherence of the second-color laser beam, and thus the speckle effect of the beam emitted by the laser projection device is further improved.

The second-color laser chip 111b is the blue laser chip or the green laser chip, and the laser beam emitted by the second-color laser chip 111b and the laser beam emitted by the first-color laser chip 111a have different colors. In some embodiments, the first-color laser chip 111a is the blue laser chip, and the second-color laser chip 111b is the green laser chip. In some embodiments, the first-color laser chip 111a is the green laser chip, and the second-color laser chip 111b is the blue laser chip.

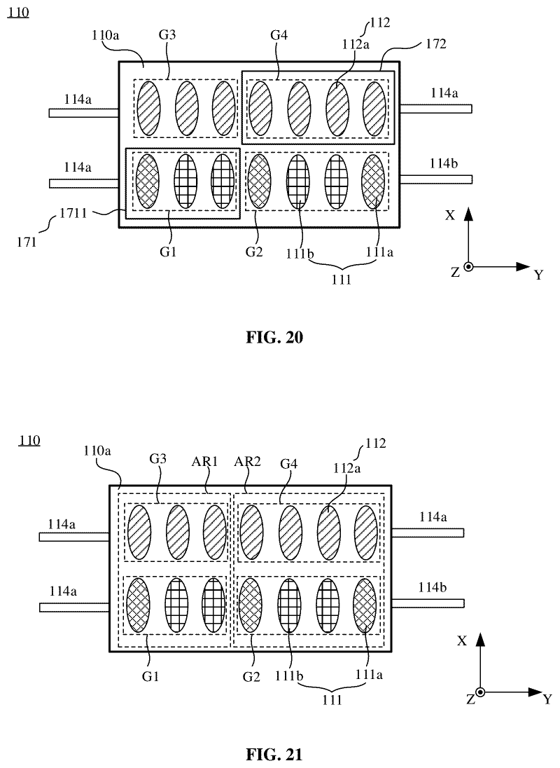

FIG. 19 is a structural diagram of a light source according to some embodiments. FIG. 20 is a schematic structural diagram of a laser array, a first polarization conversion unit, and a second polarization conversion unit in the light source illustrated in FIG. 19. Referring to FIG. 19 and FIG. 20, in some embodiments, the light source 10 further includes a second polarization conversion unit 172. Along the beam-emitting direction of the second row of laser chips, the second polarization conversion unit 172 is arranged between the red laser chips 112a in the second row of laser chips 112 and the combining minor group 120. In some embodiments, on a light-emergent surface 110a of the laser array 110, an orthographic projection of a portion of the red laser chips 112a in the second row of laser chips 112 is within an orthographic projection of the second polarization conversion unit 172. In this way, a red laser beam emitted by that portion of the red laser chips 112a in the second laser chip group G1 is incident to the combining mirror group 120 through the second polarization conversion unit 172.

Similar to the first polarization conversion unit 171, the second polarization conversion unit 172 is configured to change the polarization direction of a laser beam incident to the second polarization conversion unit 172. In some embodiments, the second polarization conversion unit 172 receives the red laser beam emitted by that portion of the red laser chips 112a in the second row of laser chips 112 and changes the polarization direction of the laser beam. In some embodiments, the polarization direction of the laser beam is rotated by 90°. In this way, similarly to the first-color laser beam or the second-color laser beam, the red laser beam incident to the combining mirror group 120 has two polarization directions, which reduces the coherence of the red laser beam, and thus the speckle effect of the beam emitted by the laser projection device is further improved.

It should be noted that, referring to FIG. 20, the number of laser chips included in the first laser chip group G1 is not limited in the present disclosure. In some embodiments, the first laser chip group G1 includes three laser chips. Alternatively, the first laser chip group G1 includes four laser chips. Similarly, the number of the portion of the red laser chips corresponding to the second polarization conversion unit 172 is not limited herein. In some embodiments, the number of the portion of the red laser chips is three. Alternatively, the number of the portion of the red laser chips is four.

It should be noted that, in some embodiments, the light source 10 includes the first polarization conversion unit and does not include the second polarization conversion unit. In other embodiments, the light source 10 includes the second polarization conversion unit and does not include the first polarization conversion unit. In yet other embodiments, referring to FIG. 19 and FIG. 20, the light source 10 includes both the first polarization conversion unit 171 and the second polarization conversion unit 172. In this case, in the light source 10, each of the first-color laser beam, the second-color laser beam, and the red laser beam has two polarization directions, such that the coherence of the laser beam of the same color is low, and thus the speckle effect of the beam emitted by the laser projection device is further improved.

Referring to FIG. 19 and FIG. 20, in some embodiments, the light source 10 includes the first polarization conversion unit 171 and the second polarization conversion unit 172. The polarization direction of the laser beam emitted by the first-color laser chip 111a and the second-color laser chip 111b is in a first polarization direction, and the polarization direction of the laser beam emitted by the red laser chip 112a is the second polarization direction. The first polarization conversion unit 171 is configured to convert the laser beam with the first polarization direction to the laser beam with the second polarization direction. The second polarization conversion unit 172 is configured to convert the laser beam with the second polarization direction to the laser beam with the first polarization direction.

In some embodiments, the first-color laser chip 111a is the blue laser chip, the second-color laser chip 111b is the green laser chip, and the blue laser beam and the green laser beam are both the S polarized light with the first polarization direction. The red laser beam is the P-polarized light with the second polarization direction. In this case, the first polarization direction is perpendicular to the second polarization direction. In some embodiments, both the first polarization conversion unit 171 and the second polarization conversion unit 172 are half-wave plates, and the half-wave plate rotates a polarization direction of a laser beam incident to the half-wave plate by 90°. In this way, a portion of the red laser beam received by the combining mirror group 120 has the first polarization direction and another portion has the second polarization direction. A portion of the first-color laser beam and the second-color laser beam received by the combining minor group 120 has the first polarization direction, and the other portion of that has the second polarization direction. In this way, the coherence of the red laser beam, the first-color laser beam, and the second-color laser beam in the light source 10 is small, and thus the speckle effect of the beam emitted by the laser projection device is further improved. In addition, each of the laser beams of three colors received by the combining mirror group 120 has two different polarization directions, and the two different polarization directions are the first polarization direction and the second polarization direction. In this way, the polarization properties of the three laser beams in the light source 10 are more uniform, which facilitates the regulation of the three laser beams and simplifies the structure of the light source.

In some embodiments, the second row of laser chips 112 includes a first red laser chip group G3 and a second red laser chip group G4. The first red laser chip group G3 includes at least one red laser chip 112a, and the second red laser chip group G4 includes at least one red laser chip 112a. In some embodiments, the first red laser chip group G3 includes a plurality of red laser chips 112a, and the plurality of red laser chips 112a are arranged successively. Similarly, in some embodiments, the second red laser chip group G3 includes a plurality of red laser chips 112a, and the plurality of red laser chips 112a are arranged successively.

The second polarization conversion unit 172 is arranged between the second red laser chip group G4 and the combining minor group 120. In this way, the red laser beam emitted by each of the red laser chips 112a in the second red laser chip group G4 is incident to the combining mirror group 120 through the second polarization conversion unit 172.

In some embodiments, the first laser chip group G1 and the first red laser chip group G3 are arranged in a row in the laser array 110. The second laser chip group G2 and the second red laser chip group G4 are arranged in a row in the laser array 110. In some embodiments, the first laser chip group G1 and the first red laser chip group G3 are arranged in a row in the laser array 110 along the first direction X, and the second laser chip group G2 and the second red laser chip group G4 are arranged in a row in the laser array 110 along the first direction X.

FIG. 21 is a structural diagram of a laser array according to some embodiments. Referring to FIG. 20 and FIG. 21, the first laser chip group G1 and the first red laser chip group G3 are arranged in a row in the laser array 110, and the second laser chip group G2 and the second red laser chip group G4 are arranged in a row in the laser array 110. Therefore, the laser array 110 has a first region AR1 and a second region AR2. The first laser chip group G1 and the first red laser chip group G3 that are arranged in a row are disposed in the first region AR1, and the second laser chip group G2 and the second red laser chip group G4 that are arranged in a row are disposed in the second region AR2.

The laser beam emitted by the first laser chip group G1 has the first polarization direction, which has the second polarization direction after passing through the first polarization conversion unit 171, and the laser beam emitted by the first red laser chip group G3 has the second polarization direction. Therefore, all the laser beams emitted from the first region AR1 have the second polarization direction. Similarly, the laser beam emitted by the second laser chip group G2 has the first polarization direction, and the laser beam emitted by the second red laser chip group G4 has the second polarization direction, which has the first polarization direction after passing through the second polarization conversion unit 172, therefore, the laser beams emitted from the second region AR2 all have the first polarization direction. In this way, the polarization properties of the three laser beams in the light source 10 are more uniform and the distribution is more regular, which facilitates the regulation of these three laser beams and simplifies the structure of the light source.

Referring to FIG. 19 and FIG. 20, in some embodiments, the combining mirror group 120 includes a third combining unit 123 and a fourth combining unit 124. The third combining unit 123 is configured to receive the beam emitted by the first laser chip group G1 passing through the first polarization conversion unit 171 and is configured to receive the beam emitted by the first red laser chip group G3. In this way, the third combining unit 123 is configured to receive the first-color laser beam, the second-color laser beam, and the red laser beam that have the second polarization direction.

The fourth combining unit 124 is configured to receive the beam emitted by the second laser chip group G2 and is configured to receive the beam emitted by the second red laser chip group G4 passing through the second polarization conversion unit 172. In this way, the fourth combining unit 124 is configured to receive the first-color laser beam, the second-color laser beam, and the red laser beam that have the first polarization direction.

The third combining unit 123 and the fourth combining unit 124 combine the respective received laser beams, such that the laser beam in a first polarization state and the laser beam in a second polarization state are uniformly mixed into a mixed beam, and thus the laser beam exited from the combining mirror group 120 has a lower coherence, thereby improving the speckle effect of the beam emitted from the laser projection device and improving the projection effect of the laser projection device.

Referring to FIG. 19, in some embodiments, an arrangement direction of the third combining unit 123 and the fourth combining unit 124 is parallel to the row direction of the first row of laser chips 111 or the second row of laser chips 112. In some embodiments, the row direction of the first row of laser chips 111 is parallel to the row direction of the second row of laser chips 112. In this case, three directions, an arrangement direction of the third combining unit 123 and the fourth combining unit 124, the row direction of the first row of laser chips 111, and the row direction of the second row of laser chips 112, are parallel to each other, such as are all parallel to the second direction Y.

According to the above embodiments, the third combining unit 123 and the fourth combining unit 124 combine two laser beams of the same color but with different polarization directions and emitted by the same row of laser chips, and the optical path of the combining minor group is simple and the structure of the light source is also simple.

In some embodiments, the third combining unit 123 includes a third reflector 1231 and the fourth combining unit 124 includes a polarization beam splitter 1241. The third reflector 1231 is configured to reflect the received beam to the polarization beam splitter 1241. The polarization beam splitter 1241 is configured to transmit the beam reflected by the third reflector 1231, and the polarization beam splitter 1241 is further configured to reflect the beam transmitted through the second polarization conversion unit 172 and to reflect the beam emitted by the second laser chip group G2.

The polarization beam splitter 1241 allows the polarized light as incident with the second polarization direction to pass completely, while reflecting the polarized light as incident with the first polarization direction. In this way, the polarization beam splitter 1241 is capable of directing the received laser beam in the first polarization state and the received laser beam in the second polarization state toward the subsequent optical elements after combining, such that the laser beam in the first polarization state and the laser beam in the second polarization state are uniformly mixed into a mixed beam, and thus the mixed beam has a low coherent.

Referring to FIG. 19, in some embodiments, the first polarization conversion unit 171 includes a first wave plate 1711. The first wave plate 1711 is configured to receive a beam (i.e., the first-color laser beam) emitted by at least one first-color laser chip 111a included in the first laser chip group G1, and to receive a beam (i.e., a first-color laser beam) emitted by the at least one second-color laser chip 111b included in the first laser chip group G1. In this way, each of the first-color laser chips 111a and each of the second-color laser chips 111b in the first laser chip group G1 correspond to one first wave plate 1711, such that the structure of the first polarization conversion unit 171 is simple.

In some embodiments, the first wave plate 1711 is configured according to one of two wavelengths corresponding to the first-color laser beam and the second-color laser beam. In some embodiments, the first wave plate 1711 is configured according to an intermediate value of the two wavelengths corresponding to the first-color laser beam and the second-color laser beam.

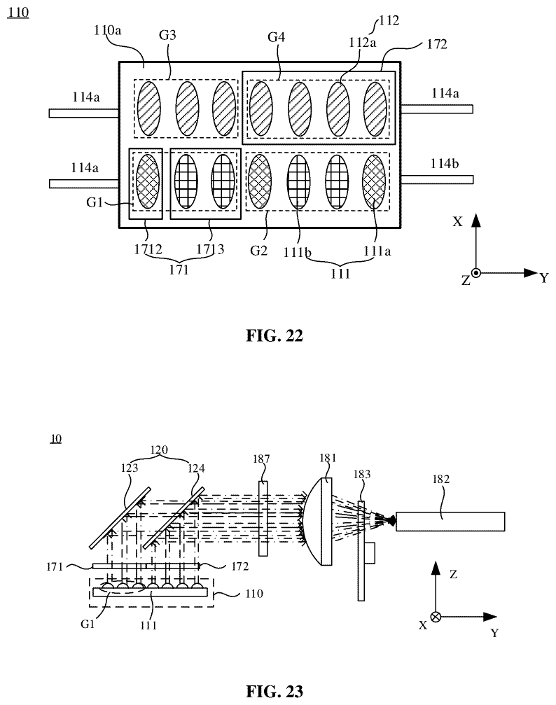

FIG. 22 is a structural diagram of a laser array, a first polarization conversion unit, and a second polarization conversion unit according to some embodiments. Referring to FIG. 22, in some embodiments, the first polarization conversion unit 171 includes a second wave plate 1712 and a third wave plate 1713. The second wave plate 1712 is configured to receive a beam (i.e., the first-color laser beam) emitted by the at least one first-color laser chip 111a included in the first laser chip group G1. The third wave plate 1713 is configured to receive a beam (i.e., the second-color laser beam) emitted by the at least one second-color laser chip 111b included in the first laser chip group G1. In this way, the second wave chip 1712 is configured according to the wavelength of the first-color laser beam, and the third wave chip 1713 is configured according to the wavelength of the second-color laser beam, such that the polarization directions of the first-color laser beam and the second-color laser beam to change by 90° after respectively passing through the second wave chip 1712 and the third wave chip 1713.

FIG. 23 is a structural diagram of another light source according to some embodiments. Referring to FIG. 23, in some embodiments, the light source 10 further includes a diffuser component 187, a beam-reducing lens 181, a speckle-eliminating member 183, and a second homogenizing member 182. Along the beam-emitting direction of the combining mirror group 120, the diffuser component 187, the beam-reducing lens 181, the speckle-eliminating member 183, and the second homogenizing member 182 are arranged in sequence.

For the description of the beam-reducing lens 181, the speckle-eliminating member 183, and the second homogenizing member 182, reference is made to the relevant description above, which is not repeated herein.

Described above are merely exemplary embodiments of the present disclosure, and are not intended to limit the protection scope of the present disclosure. Therefore, any variations or substitutions, and various combinations of features made without conflict proposed by those skilled in the art within the technical scope disclosed by the present disclosure shall be included in the protection scope of the present disclosure. Therefore, the protection scope of the present disclosure shall be subject to the protection scope of the claims.

What is claimed is:

1. A light source, comprising:
a laser array, wherein the laser array comprises:
a substrate;
a first row of laser chips disposed on the substrate, wherein the first row of laser chips comprises at least one first-color laser chip and at least one second-color laser chip, the first-color laser chip and the second-color laser chip emitting laser beams of different colors; and
a second row of laser chips disposed on the substrate, wherein the second row of laser chips comprises at least three third-color laser chips;
wherein central wavelengths of two adjacent third-color laser chips in the second row of laser chips are different.

2. The light source according to claim 1, wherein a central wavelength of each third-color laser chip in the second row of laser chips increases in sequence from an edge region to a central region along a row direction of the second row of laser chips.

3. The light source according to claim 1, wherein the third-color laser chip is configured to emit red laser beams.

4. The light source according to claim 3, wherein
the second row of laser chips comprises at least one first red laser chip disposed in the central region and at least two second red laser chips disposed on two sides of the at least one first red laser chip; wherein
the at least one first red laser chip has a first central wavelength, and among the at least two second red laser chips, central wavelengths of two second red laser chips which are equidistant from the central region are equal.

5. The light source according to claim 3, wherein
the first-color laser chip is configured to emit a blue laser beam, and the second-color laser chip is configured to emit a green laser beam; and
at least one of two edge regions in a row direction of the first row of laser chips is provided with the first-color laser chip.

6. The light source according to claim 5, wherein
both the two edge regions in the row direction of the first row of laser chips are provided with the first-color laser chips;
at least one first-color laser chip is disposed between two first-color laser chips respectively disposed in the two edge regions in the row direction of the first row of laser chips, and is disposed between two second-color laser chips.

7. The light source according to claim 3, wherein
the first-color laser chip is configured to emit a blue laser beam, and the second-color laser chip is configured to emit a green laser beam; and
in the first row of laser chips, a number of the second-color laser chips is greater than a number of the first-color laser chips.

8. The light source according to claim 7, wherein
a number of the third-color laser chips is more than the number of the second-color laser chips.

9. The light source according to claim 8, wherein the number of the third-color laser chips is equal to a sum of the number of the first-color laser chips and the number of the second-color laser chips.

10. The light source according to claim 1, wherein
the laser array further comprises three first conductive pins and one second conductive pin that are disposed on the substrate; wherein
the three first conductive pins are respectively connected to a first end of a plurality of third-color laser chips connected in series, a first end of a plurality of first-color laser chips connected in series, and a first end of a plurality of second-color laser chips connected in series;
the second conductive pin is connected to a second end of the plurality of third-color laser chips connected in series, a second end of the plurality of first-color laser chips connected in series, and a second end of the plurality of second-color laser chips connected in series; and
one of the first conductive pin and the second conductive pin is a positive pin and another is a negative pin.

11. A light source, comprising:
a laser array comprising a substrate, and a first row of laser chips and a second row of laser chips disposed on the substrate, wherein the first row of laser chips comprises at least one first-color laser chip and at least one second-color laser chip, the first-color laser chip and the second-color laser chip emitting laser beams of different colors; and wherein the second row of laser chips comprises at least three third-color laser chips, central wavelengths of two adjacent third-color laser chips in the second row of laser chips being different;
a combining mirror group, configured to combine laser beams emitted by the laser array; and
a shaping minor group, configured to receive a beam exited from the combining mirror group and to shape the beam as received, such that a width of a light spot of the beam exited from the shaping mirror group in a long side direction of the light spot is less than a width of a light spot of the beam incident to the shaping minor group in a long side direction of the light spot.

12. The light source according to claim 11, wherein
the shaping mirror group comprises a first cylindrical arc surface and a second cylindrical arc surface, the first cylindrical arc surface being proximal to the combining mirror group relative to the second cylindrical arc surface along a beam-emitting direction of the laser array; and
the shaping minor group is configured to converge, in a long side direction of a light spot of the beam exited from the combining minor group, the beam by the first cylindrical arc surface, and the shaping minor group is further configured to collimate the converged beam by the second cylindrical arc surface.

13. The light source according to claim 12, wherein
the shaping minor group comprises a first cylindrical lens and a second cylindrical lens, the first cylindrical lens being more proximal to the combining mirror group relative to the second cylindrical lens along the beam-emitting direction of the laser array; and
the first cylindrical lens is provided with the first cylindrical arc surface, and the second cylindrical lens is provided with the second cylindrical arc surface.

14. The light source according to claim 13, wherein
the first cylindrical lens is a plano-convex cylindrical lens, and the second cylindrical lens is a plano-concave cylindrical lens or a plano-convex cylindrical lens;
a generatrix of the first cylindrical arc surface of the first cylindrical lens is parallel to a generatrix of the second cylindrical arc surface of the second cylindrical lens; and
a focus of the second cylindrical lens is in coincidence with a focus of the first cylindrical lens.

15. The light source according to claim 11, wherein
the first row of laser chips comprises a first laser chip group and a second laser chip group, wherein the first laser chip group comprises at least one first-color laser chip, and the second laser chip group comprises at least one first-color laser chip; and
the light source further comprises:
a first polarization conversion unit disposed, along a beam-emitting direction of the first laser chip group, between the at least one first-color laser chip and the combining mirror group.

16. The light source according to claim 15, wherein
the first laser chip group further comprises at least one second-color laser chip, and the second laser chip group further comprises at least one second-color laser chip.

17. The light source according to claim 15, further comprising
a second polarization conversion unit disposed, along a beam-emitting direction of the second row of laser chips, between the third-color laser chips in the second row of laser chips and the combining minor group.

18. The light source according to claim 16, wherein
the first polarization conversion unit comprises a first wave plate, the first wave plate being configured to receive a beam emitted by the at least one first-color laser chip of the first laser chip group and to receive a beam emitted by the at least one second-color laser chip of the first laser chip group.

19. The light source according to claim 16, wherein the first polarization conversion unit comprises a second wave plate and a third wave plate, the second wave plate being configured to receive the beam emitted by the at least one first-color laser chip of the first laser chip group and the third wave plate being configured to receive the beam emitted by the at least one second-color laser chip of the first laser chip group.

20. A laser projection device comprising:
a light source, configured to emit a laser beam;
an optical machine, configured to modulate a beam incident to the optical machine based on an image signal; and
a lens head, configured to form a projection image by projecting a beam incident to the lens head;
wherein the light source comprises a laser arraya laser array comprising a substrate, and a first row of laser chips and a second row of laser chips disposed on the substrate, wherein the first row of laser chips comprises at least one first-color laser chip and at least one second-color laser chip, the first-color laser chip and the second-color laser chip emitting laser beams of different colors; and wherein the second row of laser chips comprises at least three third-color laser chips, central wavelengths of two adjacent third-color laser chips in the second row of laser chips being different.
